(19) United States
(12) Patent Application Publication
(10) Pub. No.: US 2025/0260660 A1
(43) Pub. Date: Aug. 14, 2025

(54) SYSTEMS AND METHODS FOR DETECTING A LOCATION BASED EVENT AND APPLYING A RULES ENGINE

(71) Applicant: State Farm Mutual Automobile Insurance Company, Bloomington, IL (US)

(72) Inventor: Christian T. Kang, Normal, IL (US)

(21) Appl. No.: 19/027,630

(22) Filed: Jan. 17, 2025

Related U.S. Application Data
(60) Provisional application No. 63/553,483, filed on Feb. 14, 2024.

(51) Int. Cl. H04L 51/21; G06F 40/205; G06Q 40/08

(52) U.S. Cl. CPC H04L 51/21; G06F 40/205; G06Q 40/08

(57) ABSTRACT

A computer system for analyzing evacuation order messages. The computer system includes a rules engine and processor programmed to: a) detect an evacuation order message associated with an evacuation authority, b) parse the evacuation order message to determine one or more endpoints of an evacuation area identified in the evacuation order message, c) determine a geographic area between the one or more endpoints, the geographic area defining the evacuation area, d) identify, by applying the rules engine, a property location located within the evacuation area, f) determine, by applying the rules engine, that a parametric insurance policy associated with the property location is triggered, and g) electronically transmit a notification message to an insured party associated with the parametric insurance policy notifying the party that funds associated with the parametric insurance policy have been transferred to the insured party.

### CROSS-REFERENCE TO RELATED APPLICATIONS

This application claims priority to and the benefit of the filing date of provisional U.S. Patent Application No. 63/553,483 entitled “DATA PROCESSING SYSTEMS AND METHODS FOR PROVIDING EVACUATION ALERTS,” filed on Feb. 14, 2024, the entire contents of which is hereby incorporated herein by reference.

### FIELD OF THE DISCLOSURE

The present disclosure relates to detecting location based events and applying a rules engine to those events and, more particularly, to systems and methods for detecting a location based event by monitoring data collected from various sources to identify a property located within a geographic location included within an evacuation order, and applying a rules engine to the event to determine whether a parametric insurance policy is triggered and whether funds may be transferred to the insured parties.

### BACKGROUND

Evacuation orders may be issued in response to natural disasters (e.g., floods, fires, hurricanes, and the like) or in response to other threats (e.g., a man-made disaster). Persons impacted by evacuation orders may have limited warnings and/or the funds necessary to travel outside of the evacuation area. Additionally, persons impacted by an evacuation order may be unaware of the latest evacuation data or, in some cases, may be completely unaware of the evacuation order. Furthermore, persons may have insufficient warning to prepare for an evacuation (e.g., scheduling travel plans or saving for travel expenses such as gas, tickets, hotel fees, and the like). For example, persons may need to use savings, or in some cases, persons may have insufficient funds, and as such, some persons may be unable to evacuate before the start of the evacuation event.

A variety of institutions, such as federal, state, and local agencies, may issue an evacuation order for an evacuation area. Persons may be tasked with monitoring various sources (e.g., media sources and/or websites) to determine if they will be impacted by an evacuation order. Monitoring the various sources may be challenging and/or stressful for a person as there may be other tasks that require attention during a disaster, such as, covering windows and doors, turning off gas/water, clearing yard of debris, or moving pets and/or livestock. For instance, there may be limited access to internet or media sources (e.g., caused by electricity outages) such that a person may be unaware of the details of the disaster and/or an evacuation order. Furthermore, an evacuation order often may identify general geographic areas or locations and these general, sometimes vague, geographic areas may not have enough detail for persons to quickly and easily determine if a person's residence is contained within the identified impacted areas.

Accordingly, there exists a need to revise current techniques of detecting location based events (e.g., evacuation orders) and applying a rules engine to the event to automatically determine whether a parametric insurance policy has been triggered, and if a triggering has occurred, transferring funds to the insured parties along with a notification message advising the insured parties of the same. Conventional techniques may include additional inefficiencies, encumbrances, ineffectiveness, and/or other drawbacks, as well.

### BRIEF SUMMARY

The present embodiments may relate to, inter alia, a computer system for analyzing evacuation order messages and determining a location of selected properties relative to the evacuation order based on a mapping of text or images representing the evacuation order to a geographically defined location or area and then to a number of properties located within that geographically defined location or area. The computer system may include a processor and a rules engine, e.g., a parametric rules engine for disbursing a predetermined fund amount based on one or more triggering events. The processor may be programmed to electronically detect an evacuation order message and parse the evacuation order message to determine one or more endpoints of an evacuation area. The processor may also be programmed to determine properties, such as homes or residences, located within the evacuation area. In response to determining that a user's property or residence location is located within the evacuation area, the processor may execute the rules engine to determine whether a parametric insurance policy applies to the residence location and whether the parametric insurance policy is triggered by the event such that funds should be automatically transferred to the insured parties and a notification message sent to the insured parties notifying them of the transfer of funds. The acquiring of the evacuation order, the mapping of its data to a geographically defined area and the identification of selected properties within that defined area, the determination of the triggering of the insurance policy by the rules engine, and the electronic distribution of funds with messaging may all be automatically done, without external intervention, by the system.

In one aspect, a computer system for implementing a parametric evacuation system to analyze evacuation order messages may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include at least one processor in communication with at least one memory, the at least one processor programmed to a) electronically detect an evacuation order message associated with an evacuation authority, b) parse the evacuation order message to determine one or more endpoints of an evacuation area identified in the evacuation order message, c) determine a geographic area between the one or more endpoints, the geographic area defining the evacuation area, d) identify, by applying the rules engine, a property location located within the evacuation area, f) determine, by applying the rules engine, that a parametric insurance policy associated with the property location is triggered, and g) electronically transmit a notification message to an insured party associated with the parametric insurance policy notifying the party that funds associated with the parametric insurance policy have been transferred to the insured party. The computer system may include additional, less, or alternate functionality, including that discussed elsewhere herein.

In another aspect, a computer-based method for implementing a parametric evacuation system to analyze evacuation order messages may be provided. The computer-implemented method may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the method is implemented by at least one processor in communication with at least one memory. The method may include a) detecting an evacuation order message associated with an evacuation authority, b) parsing the evacuation order message to determine one or more endpoints of an evacuation area identified in the evacuation order message, c) determining a geographic area between the one or more endpoints, the geographic area defining the evacuation area, d) identifying, by applying the rules engine, a property location located within the evacuation area, e) determining, by applying the rules engine, that a parametric insurance policy associated with the property location is triggered, and f) electronically transmitting a notification message to an insured party associated with the parametric insurance policy notifying the party that funds associated with the parametric insurance policy have been transferred to the insured party. The method may include additional, less, or alternate functionality, including that discussed elsewhere herein.

In yet another aspect, at least one non-transitory computer-readable storage media having computer-executable instructions embodied thereon for implementing a parametric evacuation system to analyze evacuation order messages may be provided. When executed by at least one (local or remote) processor, the computer-executable instructions may cause the at least one processor to a) electronically detect an evacuation order message associated with an evacuation authority, b) parse the evacuation order message to determine one or more endpoints of an evacuation area identified in the evacuation order message, c) determine a geographic area between the one or more endpoints, the geographic area defining the evacuation area, d) identify, by applying the rules engine, a property location located within the evacuation area, e) determine, by applying the rules engine, that a parametric insurance policy associated with the property location is triggered, and f) electronically transmit a notification message to an insured party associated with the parametric insurance policy notifying the party that funds associated with the parametric insurance policy have been transferred to the insured party. The storage media may store instructions that direct additional, less, or alternate functionality, including that discussed elsewhere herein.

In yet another aspect, a computer system for generating parametric-based notification messages using artificial intelligence tools may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include at least one (local or remote) processor, and at least one memory in communication with the at least one processor. The at least one processor may be programmed to 1) build a training dataset including a plurality of historic evacuation orders, each historic evacuation order including (a) a historic evacuation area, (b) a plurality of historic evacuation policy claims associated with the historic evacuation orders, wherein each of the plurality of claims includes a property location impacted by the historic evacuation order, and (c) a plurality of historic incident records associated with a historic incident event including a historic incident area, 2) generate an evacuation model using the training dataset, the evacuation model is trained to generate one or more model outputs when one or more model inputs are applied to the evacuation model, wherein the model outputs include at least one of (a) one or more endpoints of an evacuation area identified in the evacuation order message, (b) a geographic area between the one or more endpoints defining the evacuation area, (c) a property location located within the evacuation area, (d) a parametric insurance policy associated with the property location is triggered, 3) apply a current incident record to the trained evacuation model to generate (a) a property location located within the evacuation area, (b) a parametric insurance policy associated with the property location, (c) notification message to an insured party associated with the parametric insurance policy notifying the party that funds associated with the parametric insurance policy have been transferred to the insured party, and 4) transmit a notification message to an insured party associated with the parametric insurance policy notifying the party that funds associated with the parametric insurance policy have been transferred to the insured party. The system may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a schematic diagram of an exemplary evacuation system for detecting a location based event (e.g., evacuation order), applying a rules engine to the event, and notifying impacted users if the event is a triggering event.

FIG. 2 illustrates a data flow diagram showing data exchanged between exemplary computing devices included with the exemplary evacuation system shown in FIG. 1.

FIG. 3 is a data flow chart for use with the exemplary evacuation system shown in FIG. 1.

FIG. 4 illustrates a flow chart of an exemplary computer-implemented process for one aspect of the evacuation system shown in FIG. 1.

FIG. 5 illustrates an exemplary map showing an evacuation area determined by the evacuation system shown in FIG. 1.

FIG. 6 illustrates a simplified block diagram of an exemplary computer system for implementing the evacuation system shown in FIG. 1.

FIG. 7 illustrates an exemplary configuration of a user computer device shown in FIG. 1, in accordance with one embodiment of the present disclosure.

FIG. 8 illustrates an exemplary server configuration of a system computer device shown in FIGS. 1 and 2, in accordance with one embodiment of the present disclosure.

FIG. 9 illustrates a diagram of components of one or more exemplary computer devices that may be used in the system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, computer systems and computer-based methods for identifying users impacted by an evacuation order and providing notification messages to the identified impacted users. In one exemplary embodiment, one or more data processing operations may be performed using a system computer device that includes at least one processor communicatively coupled to at least one memory.

In the exemplary embodiment, the system computer device may receive and/or retrieve evacuation order messages associated with a mandatory evacuation order, an advisory evacuation order, and/or related to an evacuation event (e.g., issued by any suitable evacuation authority). Each evacuation order message may include a description (e.g., text or graphics) which describes the evacuation event.

An evacuation event may include, for example and without limitation, a natural disaster, such as fire, flood, hurricane, tornado, tsunamis, volcanoes, earthquake, wildfire, hurricane, tidal wave, asteroid or meteor collision, and the like. Additionally, and/or alternatively, the evacuation event may include another type of threat, for example and without limitation, a man-made disaster, fire, explosion, bomb, chemical spill, a public health emergency, and the like. In the embodiments described herein, an evacuation event refers to any event that triggers the issuance of an evacuation order.

Evacuation authorities may include, for example and without limitation, federal, state, and/or local agencies, Center for Disease Control, law enforcement, fire department, public health agencies, an emergency alert system, or any other suitable authority which may issue an evacuation order message for an evacuation event. Additionally, and/or alternatively, an evacuation order message may be presented indirectly from an evacuation authority, e.g., by a news station, social media site, website, application program interface, and/or a digital messaging system.

In the exemplary embodiments, the system may include a monitoring module in communication with, executable by, or associated with, the system computer device. In some embodiments, the monitoring module may detect (e.g., receive and/or retrieve) an evacuation order message associated with an evacuation order from, directly or indirectly, an evacuation source associated with an evacuation authority. Additionally, or alternatively, the monitoring module may monitor a website, a digital mailing system, and/or any suitable posting site, in which the evacuation authority may post an evacuation order message.

In some embodiments, the evacuation order message may be obtained from various sources or entities other than directly from the evacuation authority. For example, in some embodiments, the system may receive and/or retrieve evacuation order messages from a public messaging system associated with the Federal Emergency Management System or the National Emergency Alert system, and the like. As such, retrieving or receiving an evacuation order message by the monitoring module may refer to monitoring (periodically or with a suitable frequency) various sources and receive or retrieving evacuation order messages from different computer devices or sources associated with different evacuation authorities.

In some embodiments, evacuation order messages may be retrieved or received from various sources and evacuation order messages may be in different formats (e.g., having various data structures, various programming languages, and/or various provided data). For example, in some embodiments, an evacuation order message may be in the form of a message, including text, and/or an evacuation order message may include images or graphics, such as a map. In some embodiments, an evacuation area may be described by a textual description indicating the evacuation area, e.g., street addresses, impacted counties or cities, latitude and longitude, landmarks, etc.

In the exemplary embodiments, the computer system may include a translation module in communication with, executable by, or associated with, the system computer device. The translation module may parse data contained in the various types of evacuation order messages to determine an evacuation area, as is identified by the evacuation authority. The translation module may utilize the parsed data contained in the evacuation order messages to determine evacuation times (e.g., an evacuation start time, an evacuation end time, an evacuation duration) and/or evacuation event data. In some embodiments, the translation module may parse any suitable data from the evacuation order messages, necessary to enable the system to function as described herein. In some embodiments, the translation module reconfigures or compiles the parsed data into any suitable data structure.

In some embodiments, the system computer device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and/or other electronic or electrical components, including those mentioned elsewhere herein, which may be in wired or wireless communication with one another.

In some embodiments, the system may also detect (e.g., receive or retrieve) incident reports, associated with an incident, detected by one or more monitoring agencies. Incidents may refer to an event that may potentially result in the issuance of an evacuation order, e.g., a natural disaster or a threat, examples listed above. The monitoring agencies include, for example and without limitation, the National Oceanic and Atmospheric Administration, the National Weather Service, a private weather application (e.g., Accuweather and/or The Weather Channel, etc.), the United States Geological Survey, The Office of Wildland Fire, and the like. The translation module may also translate and parse data contained in the various types of incident reports received and/or retrieved from the incident sources.

The computer system may utilize an incident report to determine and/or predict that an evacuation order may be provided (e.g., prior to an evacuation authority issuing a formal evacuation order). The system may evaluate an incident report in order to determine an advanced warning of a potential or upcoming evacuation order. In some embodiments, the system may receive or retrieve an incident report, which may cause the system to monitor, with increased frequency, evacuation sources (e.g., an evacuation authority computer device and/or websites associated therewith) based upon data contained in the incident report. For example, the system computer device may parse and/or translate data contained within the incident report to determine, for example, a location/area of an incident and/or type of incident, and the system computer device may utilize the parsed and translated data to select one or more evacuation authorities to monitor with increased frequency (e.g., every 30 seconds, every minute, or every five minutes), as compared to monitoring rates of other evacuation authorities (e.g., every five minutes, every ten minutes, every 30 minutes, etc.).

Accordingly, the system may be enabled to monitor, continuously and simultaneously, multiple different sources (e.g., multiple different evacuation authorities and multiple different monitoring agencies) to determine the most recent evacuation order messages and/or incident reports. The system may also compare and compile parsed and translated data to determine the most accurate and up to date information.

The system computer device may also be communicatively coupled to a database that may store a plurality of parametric user records, each associated with a user (e.g., an insured party such as a homeowner and/or policy holder) enrolled with the system. In some embodiments, the parametric user record may be associated with a parametric insurance policy and the user may the holder of the parametric insurance policy. Each parametric user record may include a resident location associated with the user, the parametric user record indicating the location of the residence using an address, a latitude/longitude, a county, a city, a state, and/or any other suitable data necessary for the system computer device to identify the location of the residence.

In some embodiments, the system computer device may be communicatively coupled to, or associated with, an insurance computer device associated with an insurance agency providing insurance policies for users and/or the residences of the users. In some embodiments, the insurance agency may store the plurality of parametric user records each associated with a policy.

After receiving/retrieving an evacuation order and parsing or translating or mapping the evacuation order message to determine the evacuation area, the system computer device may determine one or more parametric user records having a residence or property location included in the evacuation area by electronically mapping the identified properties to the defined geographic evacuation area. In various embodiments described herein, upon determining the evacuation area, the system computer device may compare or map users' residence locations to the evacuation area, to determine if which users, if any, are considered impacted users (e.g., are associated with residences located within the evacuation area), or a non-impacted users (e.g., associated with residences not located within the evacuation area).

In alternative embodiments, the system computer device may identify non-impacted users with residences that are near, but not within, the evacuation area. For instance, non-impacted users with residences near and not within the evacuation order may desire to be alerted of an evacuation order applied nearby (e.g., even though their parametric policies may not be triggered).

In some embodiments, the system may perform a broad search to retrieve, or receive, a reduced number of parametric user records having a residence or property location that may potentially be included within the evacuation area, e.g., the parametric user records may indicate that the residence location is in the same state or within the same county as the evacuation area. Subsequently, the system may perform a more detailed evaluation on the reduced number of parametric user records by directly comparing residence locations with the evacuation area. In some embodiments, when the system computer device determines that a parametric user record includes a residence location contained within the evacuation area, the system may flag or identify these records as impacted parametric user records.

In some embodiments, the system computer device determines evacuation travel data for an impacted user from a residence to a location outside of the evacuation area. For example, the system computer device may determine an evacuation travel distance, an evacuation travel route, an evacuation travel mode, a travel cost, and/or a travel time.

In various embodiments, the system may include an evacuation model trained to determine impacted users impacted by an evacuation order message and/or to generate a notification message sent to the insured parties notifying them of the transfer of funds. In some embodiments, the system computer device may build the evacuation model (e.g., trains or tunes), using historic records including historic evacuation order messages, historic incident records, historic impacted users and/or parametric user records, and/or historic policy claims. In some embodiments, the evacuation model may be trained to predict a potential evacuation event, evacuation times, and/or evacuation areas. In some embodiments, the evacuation model may be trained to determine evacuation travel data, e.g., travel times or routes. In certain embodiments, the evacuation model may be trained to determine evacuation costs and/or evacuation fund amounts.

In some embodiments, the system computer device and/or the evacuation model may determine accurate evacuation areas having greater detail and specificity than the evacuation area identified in a single evacuation order. For example, the evacuation order messages may identify an evacuation area with limited specificity, and the system computer device may determine evacuation area, with sufficient detail and specificity, e.g., using data from a plurality of sources such as latitude and longitude of the boundary or specific streets, and/or addresses, such that the computer device may determine if residence locations are included in the evacuation area.

In certain embodiments, the system computer device and/or the evacuation model may be enabled to determine subareas, within or near the evacuation area, which have different evacuation times or evacuation events.

In some embodiments, the system computer device may parse impacted parametric user records to determine contact information of the users (e.g., user phone numbers, emails, addresses, etc.) and financial account information and the system computer device may transmit one or more notification messages to a financial institution and/or to the user computer devices, the notification message sent to the insured parties notifying them of the transfer of funds and/or a message prompting funds to be distributed to a financial account, or digital wallet, of the impacted user. The notification message, as pushed by the computer device, may also include evacuation data, e.g., a warning message indicating that an evacuation is eminent or pending, an evacuation start time and/or end time, evacuation event data, and/or evacuation travel data. The notification message may also include data that was contained within the parametric user record, such as fund amounts, policy data, and the like.

In some embodiments, the notification message may prompt the user to accept funds, initiating the issuance of funds to the user. For example, in some embodiments, the notification message provides an amount, a link to accept funds, and/or a confirmation of a preference of a fund distribution method (e.g., direct deposit financial account numbers, digital wallet, etc.). In some embodiments, the funds are distributed, in real-time, prior to, or during an evacuation event or evacuation order. For example, the system computer device may directly deposit funds (e.g., upon acceptance from the user) into a financial account associated with the user, thereby enabling the user to have access to the funds during or at the time of the evacuation order. In some embodiments, the evacuation system may issue a payment card containing the funds.

Conventional claim processing, associated with evacuation events or orders, may be time consuming, requiring a manual review of claims, manual comparison of residence or property locations with graphical data, and/or requiring a representative to inspect a residence or contact a user, increasing the time it takes to reimburse persons impacted by the evacuation order. In some embodiments described herein, the notification messages may include evacuation travel fund amount based upon a parametric value contained within the parametric user record, such that the evacuation travel funds may automatically be issued prior to, or at the time of, an evacuation order. In various embodiments described herein, evacuation travel funds may be determined without requiring a manual review of a claim or inspection by a representative, thereby expediting the evacuation travel fund process as compared to conventional methods.

Parametric amounts may refer to an amount that is pre-selected (e.g., during an enrollment phase) or prior to an evacuation order, and/or is automatically provided upon a predetermined trigger event occurring (e.g., a residence associated with a parametric policy being in an area where an evacuation order is issued). Additionally, and/or, alternatively, the parametric amounts may be based upon one or more parameters associated with the evacuation event. For example, a parametric amount may be selected based upon a range of evacuation durations. In another example, a parametric amount may be based upon evacuation travel data, e.g., evacuation travel distance or route.

In some embodiments, the system computer device may rerun the evacuation model as frequently as needed after detecting updated model inputs (e.g., receiving or retrieving new evacuation order messages or incident reports) to provide an updated model output (e.g., an updated evacuation area). For example, the evacuation authority may issue updated or revised evacuation order messages and the computer device, which is continuously monitoring (retrieving or receiving) the evacuation order messages, may subsequently apply the new evacuation areas to the evacuation model, to determine new evacuation areas, and then update users, e.g., newly impacted users which now have residences which are located on or within the updated evacuation area, or newly non-impacted users who no longer have residence which are located on or within the updated evacuation area.

In the exemplary embodiment, the system may train the evacuation model, in an initial session using an initial training dataset. The initial training dataset may include historic evacuation records. In the exemplary embodiment, the model may be updated, retrained, or retuned, after new data is available. For example, after an evacuation event, the evacuation model may be retrained using evacuation order message data that has been parsed by the translation module, as well as historically determined evacuation areas that were determined by the previously initially trained evacuation model, to generate an updated trained evacuation model that more accurately predicts evacuation data (e.g., evacuation boundaries and/or evacuation travel data). In some embodiments, the evacuation model may be retrained after an evacuation event using the historic evacuation order, the historically determined evacuation areas, the evacuation event, evacuation times, incident reports, and/or insurance claims associated with the historic evacuation order and associated geographic location of a residence.

In some embodiments, the evacuation model may utilize historic insurance claims to determine an accuracy of the determined model outputs, and then the evacuation model may be retrained to determine model outputs with improved accuracy. The evacuation model may be trained to determine a relationship between incident reports and evacuation order messages, such that the evacuation model is enabled to predict evacuation areas using a received incident report.

As such, in some embodiments, the evacuation model may be enabled to predict evacuation areas before issuance of an evacuation order and/or send an evacuation warning message prior to the evacuation event or during the evacuation event. In other words, the computer device may send evacuation order messages with urgency, such that users are not only warned about impending evacuation events but also such that users may be issued funds with minimal delay, improving user experience and providing users with funds needed to evacuate (e.g., the users may be able to use funds to acquire transportation such as rent a car, pay for gas, bus or flight fare, or to purchase hotels).

In some respects, a computer system for detecting hazards and/or analyzing data may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to (i) monitor multiple evacuation sources and monitoring sources, simultaneously and with a suitable frequency, (ii) automatically determine impacted users, and/or (iii) transmit notification messages to automatically distribute evacuation funds.

At least one of the technical problems addressed by this system may include: (i) slow or delayed manual process for determining impacted users and/or residences impacted by an evacuation order; (iii) slow or delayed issuance of funds to impacted users, and/or (iv) limited detail or resolution of evacuation areas provided by evacuation order messages, delaying ability to determine one or more users are included within an evacuation area.

A technical effect of the systems and processes described herein may be achieved by performing at least one of the following actions or operations: a) electronically detecting an evacuation order message associated with an evacuation authority by continuously monitoring selected sources of such evacuation order data so that it can be easily and automatically detected by the system without additional intervention, b) parsing the evacuation order message to determine one or more endpoints of an evacuation area identified in the evacuation order message, c) determining a geographic area between the one or more endpoints by mapping the endpoints to the geographic area, the geographic area defining the evacuation area, d) identifying, by applying the rules engine, a property location located within the evacuation area, e) determining, by applying the rules engine, that a parametric insurance policy associated with the property location is triggered, and f) electronically transmitting a notification message to an insured party associated with the parametric insurance policy notifying the party that funds associated with the parametric insurance policy have been transferred to the insured party.

The technical effect achieved by this system may be at least one of: (i) automatic identification of evacuation areas, for use in determining impacted users, residences, and/or policies; (ii) expedited transmission of notification messages to impacted users, (iii) monitoring a plurality of evacuation sources with increased monitoring frequency, (iv) monitoring a plurality of evacuation sources simultaneously, (v) parsing and translation of data contained in various evacuation order messages, (vi) expedited or automatic issuance of travel funds, and/or (vii) improved detail and resolution for a determined evacuation area or area based upon an evacuation order message.

### Exemplary Computer System

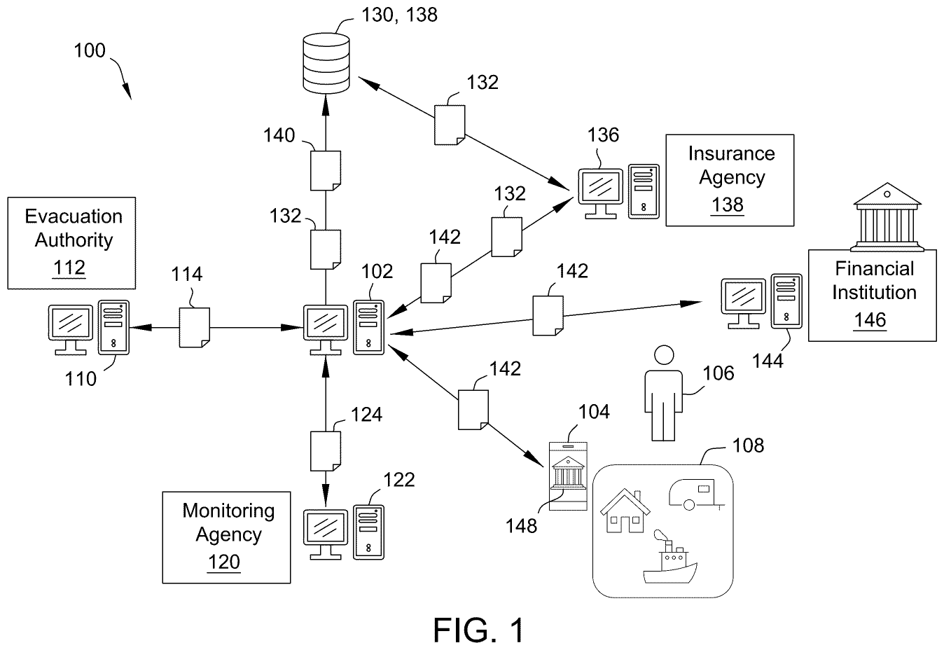

FIG. 1 depicts a schematic illustration of the data processing evacuation system (referred to herein as the evacuation system), indicated generally at 100, including a data processing system computer device 102 that is communicatively coupled to a plurality of distinct and separate computer devices including one or more user computer devices 104 associated with a user 106 (e.g., an insured party, a policyholder, or any responsible party enrolled with the system 100) and associated with a residence or property 108. Residence or property 108 may be a house. In some embodiments, residence or property 108 may be, but is not limited to, other types of structures in which a person may reside or own, such as apartments, condominiums, townhomes, motor vehicle homes, (recreational vehicles, trailers, campervans, etc.), houseboats or yachts, and the like. Evacuation system 100 further may include one or more different evacuation sources 110, e.g., computer devices, websites, social media sites, digital messaging sources, and the like, that are communicatively coupled to system computer device 102.

Each evacuation source 110 may be associated with a different evacuation authority 112 that may issue one or more evacuation order messages 114. In some embodiments, system 100 includes one or more monitoring sources 122, e.g., monitoring computer devices, websites, social media sites, digital messaging sources, which are communicatively coupled to system computer device 102. Each monitoring source 122 may be associated with a different monitoring agency 120 that may issue one or more incident reports 124.

In some embodiments, system computer device 102 may monitor with a monitoring frequency the one or more evacuation sources 110 to receive or retrieve the most recent and up to date evacuation order messages 114. In some embodiments, system computer device 102 may receive, or retrieve, evacuation order messages 114 from one or more of evacuation sources 110, simultaneously. Evacuation authorities 112 may include, for example and without limitation, federal, state, and local agencies, federal agencies, Center for Disease Control, law enforcement, fire department, public health agencies, the emergency alert system, or any other suitable authority which may issue an evacuation order message 114.

In some embodiments, the evacuation event may include, for example and without limitation, a natural disaster, such as fire, flood, hurricane, tornado, tsunamis, volcanoes, earthquake, and the like. In certain embodiments, the evacuation event may include a threat, e.g., fire, explosion, bomb, chemical spill, and the like. An evacuation event may include any event that triggers an evacuation order message 114, including a mandatory evacuation order or an advisory evacuation order.

In various embodiments, system computer device 102 may monitor with a monitoring frequency the one or more monitoring sources 122 to receive or retrieve the most recent and up to date incident reports 124. In some embodiments, system computer device 102 may receive, or retrieve, incident reports 124 from one or more of monitoring sources 122, e.g., one or more monitoring computer devices, simultaneously. Monitoring agencies 120 include, for example and without limitation, the National Oceanic and Atmospheric Administration and/or the National Weather Service, a private weather source (e.g., AccuWeather, The Weather Channel, etc.), the United States Geological Survey, and/or the Office of Wildland Fire.

Incident reports 124 may include data related to natural phenomena such as weather, volcanic activity, geological activity, solar activity, and/or oceanographic. In some embodiments, incident reports 124 may include other forms of data, for example, incident reports 124 may include social media data, political news information, animal migratory patterns, health related data including viral and bacterial contagion rates from organizations such as the World Health Organization, or data pertaining to pests, rodents, and insects, and astronomical phenomenon such as solar flares. In some embodiments, the incident reports 124 may be associated with any incident that may potentially cause issuance of an evacuation order.

In some embodiments, system computer device 102 may monitor a plurality of evacuation sources 110 and a plurality of monitoring sources 122 simultaneously. In some embodiments, system computer device 102 may receive or retrieve a plurality of evacuation order messages 114 and/or a plurality of incident reports 124, simultaneously. In some embodiments, system computer device 102 determines a suitable monitoring rate or frequency and in some embodiments, system computer device 102 utilizes different monitoring rates for different evacuation sources 110 and/or different monitoring sources 122.

Evacuation system 100 may further include a database 130 storing a plurality of parametric user records 132, each record associated with at least one residence or property 108 of user 106. System computer device 102 may retrieve parametric user records 132 or store parametric user records 132 within database 130. In some embodiments, evacuation system 100 may further include an insurance computer device 136, associated with an insurance agency 138, communicatively coupled to system computer device 102. In some embodiments, system computer device 102 may retrieve or receive parametric user records 132 from insurance computer device 136. Parametric user records 132 may be associated with a policy and a policy holder (e.g., a responsible party or user 106).

In some embodiments, evacuation system 100 may include a historic database 138 storing a plurality of historic evacuation records 140. Each historic evacuation record 140 may include a historic evacuation order message 114, a historic incident record 124, and/or a historic parametric user record 132 associated with user 106, or property 108, impacted by the historic evacuation order message 114 and/or a historic incident record 124. Historic evacuation records 140 may be associated with a historically submitted policy claim associated with a historic evacuation order.

In some embodiments, insurance computer device 136 may access database 130 to adjust or update a parametric insurance policy of the user 106. In the exemplary embodiment, user 106 may be in communication with insurance agency 138 to verify or select parametric policy levels. Parametric policy levels may be associated levels of fund amounts that may be issued to users 106 impacted by evacuation order messages 114. In some embodiments, a parametric policy level may be pre-selected by user 106.

In certain embodiments, the parametric policy level may be selected based upon evacuation data contained in evacuation order messages 114 and/or determined by an evacuation model 210, described in detail below. In some embodiments, system computer device 102 may then receive updated information from insurance computer device 136, e.g., to identify new residence or property 108 and/or residence locations associated with a new user 106. For example, system computer device 102 may receive one or more messages from insurance computer device 136, the messages identifying users 106 as at least one responsible party for property 108, and/or a selected parametric policy level.

In the exemplary embodiment, system computer device 102 monitors and evaluates evacuation order messages 114 and/or incident reports 124, and determines eligible users 106, the system computing device 102 generates one or more notification messages 142 to be transmitted to user computer device 104, insurance computer device 136, and/or a financial computing device 144 associated with one or more financial institutions 146 causing an electronic transfer of funds to a financial account 148 of the eligible user 106. To determine eligible users 106, the system computer device 102 may retrieve parametric user records 132 and compared data contained in parametric user record 132 to data parsed from evacuation order messages 114 and/or incident reports 124 to determine an impacted user 106, an impacted property 108 and/or an impacted parametric user record 132. In some embodiments, the notification message 142 sent to the insured parties notifying them of the transfer of funds and/o a message causing funds to be issued to a financial account 148 of the eligible user 106. The notification message 142 may notify the user 106 about the amount of the funds, banking information, and/or policy information. In some embodiments, notification message 142 prompts the user 106 to accept funds. In some alternative embodiments, notification message 142 may also serve as a warning to user 106 that their property 108 may, or is, impacted by evacuation order message 114 or incident report 124.

In some embodiments, user computer devices 104 may include a mobile device, a personal computer, a tablet, or a web page on another computer device. In some embodiments, evacuation order messages 114, incident reports 124, and/or notification messages 142 may be presented using any suitable platform, e.g., websites, messaging applications, application program interfaces, digital messages, social media sites, email or mailing lists, or any suitable platform.

### Exemplary Process for Data Processing and Providing Notification Messages

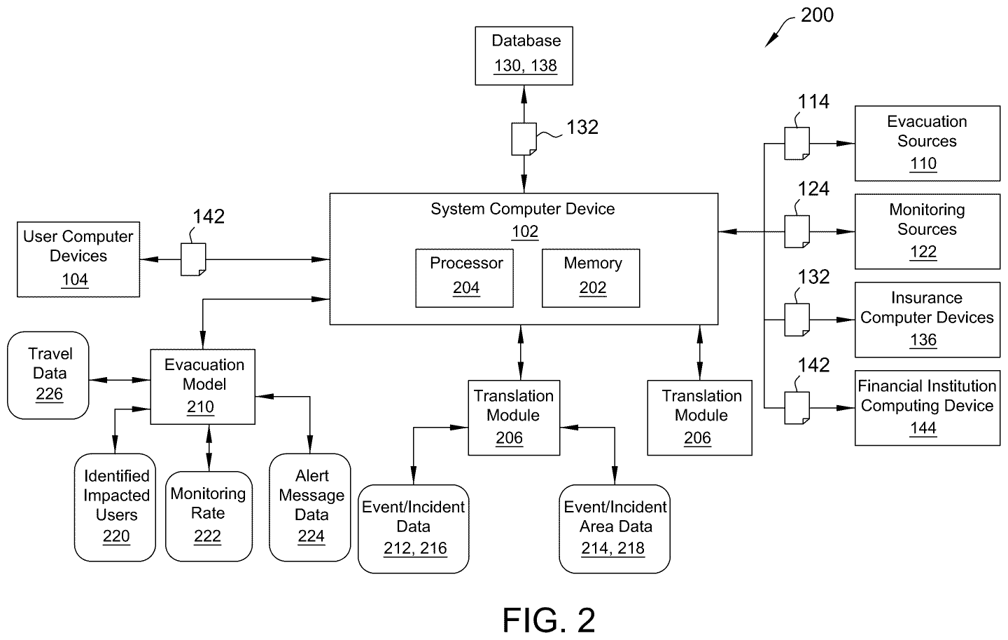

FIG. 2 depicts an exemplary configuration data flow diagram 200 for an exemplary system computer device 102, for use with evacuation system 100, shown in FIG. 1. As described above, system computer device 102 may be in communication with a plurality of different and distinct computer devices or sources, e.g., evacuation sources 110, monitoring sources 122, user computer devices 104 and/or insurance computer devices 136. System computer device 102 further includes a memory 202 and at least one processor 204 and system computer device 102 is communicatively coupled to database 130. Evacuation system 100 may also include a translation module 206, a monitoring module 208, and an evacuation model 210, associated with, or executable by system computer device 102.

In some embodiments described herein, monitoring module 208 may monitor, using a monitoring rate, a plurality of different evacuation sources 110, simultaneously, for the most recent and up to date evacuation order messages 114. For example, in some embodiments, monitoring module 208 may periodically monitor a website, a mailing list, messaging application, and/or social media posting, in which evacuation source 110 may provide evacuation order message 114.

In some embodiments, evacuation order message 114 may be issued by evacuation authority 112, however, evacuation order message 114 may be obtained from a different evacuation source 110. For example, in some embodiments, system computer device 102 may receive and/or retrieve evacuation order message 114 from evacuation source 110 including a public messaging system associated with the Federal Emergency Management System or the National Emergency Alert system, and the like. Monitoring module 208 may use a monitoring rate of, for example and without limitation, every five minutes, every ten minutes, and/or every thirty minutes.

In various embodiments described herein, monitoring module 208 may monitor, using a monitoring rate, a plurality of different monitoring sources 122, simultaneously, for the most recent and up to date incident reports 124. For example, in some embodiments, monitoring module 208 may periodically monitor a website, a mailing list, messaging application, and/or social media posting, in which monitoring source 122 may provide incident reports 124. In some embodiments, incident reports 124 may be issued by monitoring agency 120, however, incident reports 124, may be obtained from a different monitoring source 122.

Monitoring module 208 may use a monitoring rate of, for example and without limitation, every five minutes, every ten minutes, and/or every thirty minutes. As described in detail herein, the monitoring rate may be adjusted or different for different evacuation sources 110 and/or monitoring sources 122, based upon one or more determined factors or parameters determined by system computer device 102.

In various embodiments described herein, translation module 206 may be enabled to parse and translate data contained within digital messages having different formats received/retrieved from various sources. For example, in the exemplary embodiment, monitoring module 208, may receive and/or retrieve a plurality of evacuation order messages 114, associated with an evacuation event, from one or more of a plurality of evacuation sources 110. As evacuation order messages 114 may be received or retrieved from various different evacuation authorities 112 or evacuation sources 110, evacuation order messages 114 may have different formats, various data structures, various programming languages, and/or various provided data presentations or configurations.

For example, evacuation order messages 114 may include an event description, presented in text format or with graphics, describing the event that is causing the evacuation, a severity level of the event, an event start time, an event end time, event duration, and/or any other suitable data related to the evacuation event. Evacuation order messages 114 may include an evacuation area, which may be presented using text indicating, for example and without limitation, states, counties, areas, streets, addresses, longitude/latitude, landmarks, and the like, and/or the evacuation area may be presented as a map with shading, coloring, or other markings that indicate the evacuation area. Translation module 206 may parse and translate the data contained in evacuation order messages 114 to determine, if contained within evacuation order message 114, an incident/evacuation event data 212 (e.g., a description of the evacuation event and/or an evacuation times etc.) and evacuation area data 214 (e.g., evacuation area and/or evacuation maps etc.).

In some embodiments, monitoring module 208, may receive and/or retrieve a plurality of incident reports 124, associated with an incident, from one or more of a plurality of monitoring sources 122. As incident reports 124 may be received or retrieved from various different monitoring sources 122, incident reports 124 may have different formats, various data structures, various programming languages, and/or various provided data presentations or configurations.

Translation module 206 may parse data contained in incident reports 124 to determine, if contained within the incident reports 124, an incident event description, an incident duration, and/or an incident area. For example, incident reports 124 may include an incident description, presented in text format or with graphics, describing the incident, a severity level of the event, an event start time, an event end time, an event duration, and/or any other suitable data related to the incident event.

Incident reports may include an incident area and/or an evacuation area, which may be presented using text indicating, for example and without limitation, states, counties, areas, streets, addresses, longitude/latitude, landmarks, and the like, and/or the evacuation area may be presented as a map with shading, coloring, or other markings that indicating the evacuation area and evacuation area boundaries. Translation module 206 may parse and translate the data contained in incident reports 124 to determine, if contained within incident report 124, an event/incident event data 216 (e.g., a description of the evacuation event, severity level, and/or evacuation times etc.), and/or incident area data 218 (e.g., incident area and/or incident maps etc.).

In some embodiments, translation module 206 may parse and translate a plurality of different evacuation order messages 114 and/or a plurality of incident reports 124 and compiles and/or compares the parsed and translated data to determine the most accurate and up to date information.

In various embodiments, translation module 206 includes an optical character recognition (OCR) component for reconfiguring data in order to generate a machine-readable data set from the plurality of received/retrieved evacuation order messages 114 and/or incident reports 124.

In certain embodiments, system computer device 102 may utilize historical data contained in historical evacuation records 140 to generate, e.g., build and/or train, evacuation model 210. Evacuation model 210 may be a machine learning program that is trained by inputting sample data sets or certain data into the programs, such as autonomous system sensor and/or control signal data, and other data discuss herein. The machine learning programs may utilize deep learning algorithms that are primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

System computer device 102 may apply a plurality of model inputs to evacuation model 210 to determine one or more model outputs. In the illustrated embodiments, the model inputs may include parsed and translated data, generated by translation module 206, from one or more current evacuation order messages 114 and/or current incident reports 124. Model inputs may include data contained in one or more parametric user records 132. Model outputs may include an identification of impacted users and/or impacted parametric user records 220 associated with a property 108 which is, or may be, impacted by evacuation order message 114 and/or incident report. For example, evacuation model 210 may determine if the location of property 108 is contained within an evacuation area.

In some embodiments, model outputs may include a monitoring rate 222 for monitoring module 208 to monitor one or more evacuation sources 110 and/or one or more monitoring sources 122. In some embodiments, model outputs may include the notification message 142 indicating funds have been transferred into a financial account of the eligible users 106. In some embodiments, model outputs may include, for example, and without limitation, evacuation/incident event data 212, 216 and/or evacuation or incident area data 214, 218, risk level, and/or warning associated with an amount of time that would be required for the user 106 to evacuate, based on the geographic location of the user 106. In some embodiments, model outputs include evacuation travel data 226 for escaping the evacuation or incident event. Evacuation travel data 226 may include a type of travel vehicle, a travel route, a travel cost (e.g., gas, fare, hotels, etc.), and/or a travel time.

In some embodiments, the system computer device 102 may generate one or more individual evacuation models 210 each associated with a geographic location. For example, system computer device 102 may train the geographic location evacuation model 210 using historic evacuation records 140 including a historic location of a property 108 contained within the historic evacuation area.

In certain embodiments, system computer device 102 build a first training dataset including plurality of historic evacuation records including historic evacuation orders, each historic evacuation orders including the historic evacuation area and a historic evacuation policy claim associated with the historic evacuation orders. System computer device 102 trains in a first training session, an evacuation model 210 using the first training dataset.

In some embodiments, system computer device 102 may build a second training dataset including a plurality of historic evacuation records, each historic evacuation order of the historic evacuation records including (i) the historic evacuation area; (ii) a plurality of historic evacuation policy claims associated with the historic evacuation order, wherein each of the plurality of claims includes a residence or property location impacted by the historic evacuation order; and/or (iii) historic incident records associated with historic incident events including historic incident areas. System computer device 102 trains, in a second training session, the evacuation model 210 using the second training dataset.

In some embodiments, user computer device 104 may include Global Positioning Systems (GPS) sensors or other types of sensors such as front view and/or side view cameras, LIDAR, radar, weight sensors, accelerometer, gyroscope, compass and/or other types of sensors to identify the location and/or position of property 108, surrounding objects, and/or internal objects or persons. In some embodiments, property 108 may include one or more sensors that are communicatively coupled to system computer device 102. The telematics data may be used to determine whether property 108 is located within an evacuation area. In some embodiments, sensors associated with a property 108 may be configured to generate telematics data using GPS or other sensors mounted or installed on property 108.

System computer device 102 may communicate with the plurality of different computer devices in system 100, including any methods of communication as necessary, such as cellular, satellite, microwave, laser, radar, or any other method of wireless communication using the electromagnetic frequency spectrum or other media including sound, gravitational, or quantum. Any computer device in system may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Computer devices may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiment, system computer device 102 may cause user computer device 104 to display notification messages 142 on a user interface or a graphical user interface.

### Exemplary Data Flow Process for Processing and Providing Notification Messages

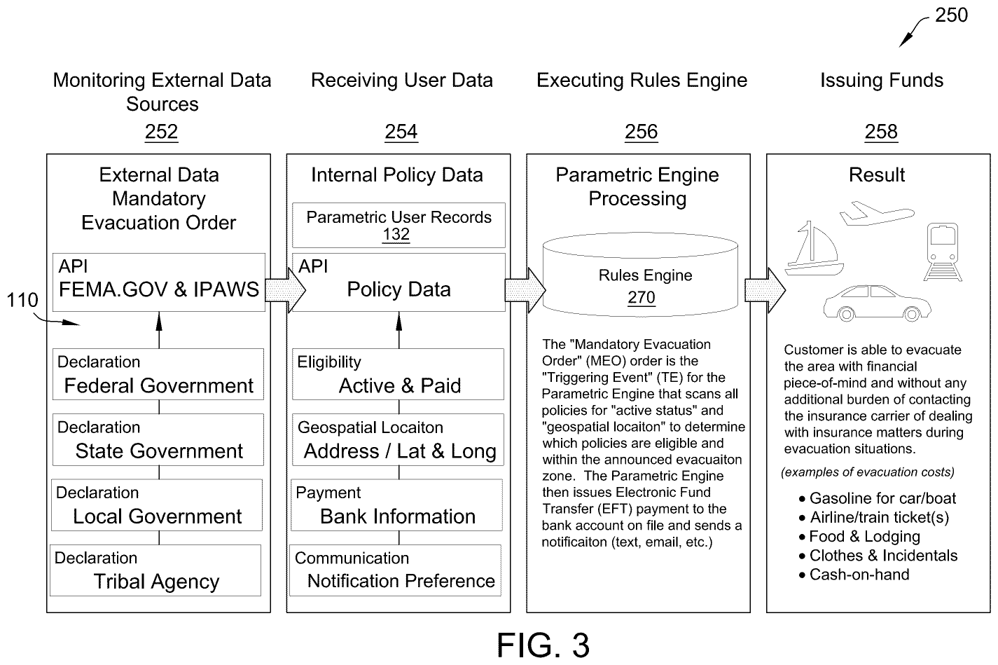

FIG. 3 is an exemplary data flow process 250 for the exemplary system computer device 102, for use with evacuation system 100, shown in FIG. 1. The data flow process 250 includes electronically and continuously monitoring 252 the plurality of evacuation sources 110 (e.g., the federal government, state government, local government, and/or tribal agencies) to determine if evacuation order messages 114 and/or incident reports 124 are issued by evacuation sources 110. These evacuation sources 110 may present evacuation order messages 114 in an application program interface (API) or website (e.g., Integrated Public Alert and Warning System (IPAWS) and/or www.fema.gov). The monitoring 252 may include parsing and translating, e.g., using translation module 206, data contained within the evacuation order messages 114 and/or incident reports 124.

The data flow process 250 may further include retrieving 254 user data, for example, stored within parametric user records 132 and/or for a user 106. User data may include policy data, eligibility data (e.g., indicating if the user 106 has an active policy), geospatial location data (e.g., residence or property location, address, latitude and longitudinal, or any suitable location data that may be used to identify a location of an insured asset, e.g., home or automotive), and/or banking information (e.g., financial account, routing and account numbers, digital wallet information, etc.). In some embodiments, the user data may include user preference data, such as a preferential communication method (e.g., text message, application program interface, email, phone call, etc.). User data and/or parametric user records 132 may include additional or alternative data, e.g., any data associated with a parametric insurance policy of the user 106.

The data flow process 250 may include executing 256 a parametric rules engine 270 to determine eligible users 106, e.g., eligible policy holder(s), that may be impacted by evacuation order messages 114 and/or incident reports 124. The rules engine 270 may evaluate one or more parametric user records 132. For example, the rules engine 270 may evaluate one or more parametric user records 132 to determine and eligibility and/or a status of a user 106, e.g., a parametric insurance policy. The rules engine 270 may also evaluate the geospatial location to determine if the user 106 us impacted by an evacuation order messages 114 and/or an incident report 124, e.g., the rules engine 270 determines that a location is contained without the boundaries of the evacuation order messages 114 and/or incident report 124. Executing the rules engine 270 may also include issuing, automatically, an electronic fund transfer to eligible users 106.

The data flow process 250 may further include issuing 258 funds to users 106, for example, automatically in response to determinations of eligible users 106. Issuing 258 funds may include transmitting a message to at least one of the financial institution 146 and/or the user computing device 104, causing funds to be distributed to the user 106 based on a saved preference of the user 106, e.g., direct deposit in a financial account 148 of the user 106.

In some embodiments, execution of the rules engine 270 may be triggered, automatically, by detection of an evacuation order message 114 and/or an incident report 124. As such, the rules engine 270 monitors evacuation order messages 114, and automatically determines impacted and eligible users 106, and issues funds, in real-time and without requiring external interaction with a representative or insurance agent to evaluate records or locations. For example, when the parametric rules engine 270 determines eligible users 106, then the parametric rules engine 270 determines a payment amount, e.g., a predetermined payment amount as previously set by a parametric rule, to be disbursed to the eligible user 106. For example, the parametric engine 270 determines triggers, e.g., a mandatory evacuation, for the parametric policy to disburse funds. In some embodiments, a parametric insurance may refer to policy that pays out a set amount (e.g., a predetermined agreed upon amount) based on when a specific, triggering, event occurs, e.g., as opposed to a policy that pays out for a particular loss.

In some embodiments, after funds are disbursed to the eligible user 106, the policy may be canceled and a renewal offer may be transmitted to the user 106.

### Exemplary Computer-Implemented Method for Data Processing and Providing Notification Messages

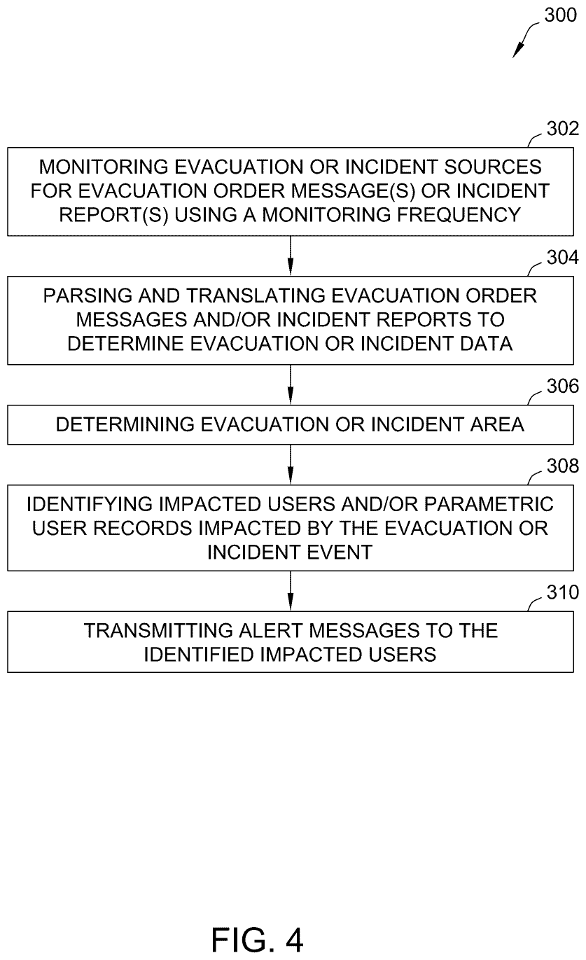

FIG. 4 illustrates a flow chart of an exemplary computer-implemented method 300 for data processing and providing notification messages 142 for use with the evacuation system 100 shown in FIG. 1. Method 300 may be implemented by a computer device, for example, system computer device 102 (shown in FIGS. 1 and 2). In the exemplary embodiment, system computer device 102 may be in communication with one or more user computer devices 104 associated with one or more users 106 (shown in FIGS. 1 and 2), one or more evacuation sources 110 (shown in FIGS. 1 and 2), and one or more monitoring sources 122 (shown in FIGS. 1 and 2).

In the exemplary embodiment, computer-implemented method may include system computer device 102 receiving user data from user computer device 104 associated with a user enrolling or registering with evacuation system. In some embodiments, the method includes the system computer device 102 building parametric user records 132 by compiling and/or reconfiguring the received user data. Method may include system computer device 102 storing parametric user records 132, for a plurality of registered users 106, within database 130. In some embodiments, method 300 may include system computer device 102 receiving user data and/or parametric user records 132 from insurance computer device 136. For example, user may be a policy holder and the user data may be associated with a parametric insurance policy.

Computer-implemented method 300 may include system computer device 102 monitoring 302, e.g., using monitoring module 208, evacuation source 110 for evacuation order messages 114. Method 300 may include system computer device 102 monitoring 302, e.g., using monitoring module 208, a plurality of evacuation sources 110, simultaneously, for a plurality of evacuation order messages 114. Monitoring 302 may include monitoring evacuation source(s) 122 using any suitable monitoring frequency.

Method 300 may include system computer device 102 monitoring 302, e.g., using monitoring module 208, monitoring source 122 for incident reports 124. Method 300 may include system computer device 102 monitoring 302, e.g., using monitoring module 208, a plurality of monitoring sources 122, simultaneously, for a plurality of incident reports 124. Monitoring 302 may include monitoring evacuation source(s) 122 using any suitable monitoring frequency.

In some embodiments, computer-implemented method 300 may include system computer device 102 verifying identities of a plurality of different evacuation authorities 112 and associated evacuation sources 110. In some embodiments, method 300 includes system computer device 102 verifying identities of a plurality of different monitoring agencies 120 and associated monitoring sources 122. In some embodiments, system computer device 102 may monitor only verified sources evacuation sources 110 and/or monitoring sources 122.

In response to receiving/retrieving evacuation order messages 114 and/or incident reports 124, computer-implemented method 300 may include system computer device 102 parsing and translating 304, e.g., using translation module 206, data contained within the evacuation order messages 114 and/or incident reports 124. Translating 304 may include compiling and/or comparing the parsed data from a plurality of evacuation order messages 114 and/or a plurality of incident reports 124, to determine the most accurate and recent data associated with an evacuation event and/or a potential evacuation event.

In some embodiments, computer-implemented method 300 may include system computer device 102 determining 306 evacuation and/or incident area data 214, 218. Determining 306 evacuation and/or incident area data 214, 218 may include system computer device 102 parsing and/or translating evacuation order message 114 and/or incident reports 124. In some embodiments, method 300 may include system computer device 102 determining 306 one or more endpoints of the evacuation and/or incident area data 214, 218 as parsed and translated from evacuation order messages 114.

In various embodiments, computer-implemented method 300 may include system computer device 102 translating evacuation areas parsed from evacuation order messages 114, into a uniform format for additional method operations or actions. In some embodiments, translating may include determining relationships between the disparate data sets, e.g., a plurality of evacuation order messages 114 and/or incident reports 124, and correlating data with one another through a single or multiple reference values such as an evacuation time, an evacuation duration, an evacuation area. In some embodiments, translating may include re-organization of the parsed data facilitating efficient and immediate access for analysis and interpretation.

In some embodiments, the computer-implemented method 300 may include system computer device 102 saving event/incident data 212, 216 and/or event/incident area data 214, 218 in database 130. In various embodiments, method 300 may include system computer device 102 accessing and/or updating the saved event/incident data 212, 216 and/or event/incident area data 214, 218, in real-time, based upon new evacuation order messages 114 and/or new incident reports 124, to dynamically update event/incident data 212, 216 and/or event/incident area data 214, 218.

Computer-implemented method 300 may include system computer device 102 identifying 308 impacted users and/or impacted parametric user records 220 which are impacted by evacuation order messages 114 and/or incident reports 124. Identifying 308 may include system computer device 102 comparing a residence or property location contained in parametric user records 132 to event/incident area data 214, 218.

In some embodiments, method 300 may include system computer device 102 parsing parametric user records 132 to determine a location of property or property 108. When the location is contained within event/incident area data 214, 218, system computer device 102 identifies and/or saves impacted users and/or impacted parametric user records 220.

In some embodiments, identifying 308 impacted users 106 and/or impacted parametric user records 220 may include system computing device 102 executing a rules engine 270, automatically in response to receiving/retrieving evacuation order messages 114 and/or incident reports 124, to determine i) a status of the users 106, and ii) if the geographic location associated with the user 106 will be impacted by the evacuation order messages 114 and/or incident reports 124, and iii) if an impacted user 106 is identified, automatically generate and transmit notification message 142 indicating that funds have been transferred to the financial account 148 of the user 106 and/or indicating the amount of funds, requesting approval or confirmation of transfer of funds, and/or other suitable information, such as relevant data parsed from the evacuation order messages 114 and/or incident reports 124. Rules engine 270 may be automatically executed, in real-time during the occurrence of the evacuation order or immediately (within 1-2 min, within 5-10 mins, or less than 30 mins) after the evacuation order messages 114 and/or incident reports 124 is received or retrieved, such that funds are transferred and may be accessible to the eligible user in a timely manner and without time consuming efforts for manual evaluation of impacted user and without requiring impacted user to request funds.

In certain embodiments, computer-implemented method 300 may include system computer device 102 pre-sorting the plurality of parametric user records 132 using geographic location criteria. For example, method 300 may include system computer device 102 pre-sorting parametric user records 132 into groups based upon location, for example, and without limitation, by state, by county, by region, and/or any suitable geographic location criterion. Method 300 may include system computer device 102 selecting a suitable group of parametric user records 132 for a group that includes geographic location criteria that encompasses the evacuation area for determining impacted users and/or impacted parametric user records 220. In certain embodiments described herein, the sorted groups of parametric user records 132 have a reduced size, as compared to all of the parametric user records 132 for all locations, thereby reducing the computational load and time required for system computer device 102 to identify impacted users and/or impacted parametric user records 220.

In response to identifying 308 at least one impacted user and/or impacted parametric user records 220, computer-implemented method 300 may include system computer device 102 transmitting 310 one or more notification messages 142 to user devices 104 associated with the identified impacted users and/or impacted parametric user records 220. In some embodiments, method 300 may include system computer device 102 transmitting 310 notification message 142 to any suitable responsible party. Notification message 142 may notify or confirm to the user that electronic funds have been issued or transferred. The notification message 142 indicate the date and/or time of the electronic funds transfer, banking information, and/or the monetary amount of the electronic funds transfer. In some embodiments, the notification message may prompt the user 106 to approve, accept, and/or confirm an electronic funds transfer. In some embodiments, the notification message 142 may include any or all of the following data, the location of property 108, event/incident area data 214, 218, and/or event/incident data 212, 216, relative location of the property 108 compared to evacuation area, evacuation travel data 226, parametric policy level and/or information, evacuation costs, and/or reimbursements funds.

In various embodiments, transmitting notification message 142 may be in the form of a text message, e-mail, telephone call, or any combination thereof. In some embodiments transmitting the notification message 142 may be through a graphical user interface executable by an application program interface on a mobile phone, web page, website, phone, text message, email, and/or any other method of communication using a wireless or other communication device such as a radio, or using any method as previously indicated as being a preferential method of communication by a user 106. In some embodiments, computer-implemented method 300 may include system computer device 102 directly depositing funds into a payment account associated with user 106. System computer device may provide funds, e.g., direct deposit, payment cards, digital wallet applications, etc., to users 106, in real time, during or prior to an evacuation order, e.g., prior to a start time of the evacuation or prior to a deadline to be evacuated.

In some embodiments, computer-implemented method 300 may include system computer device 102 parsing contact information from the impacted parametric user records 132. The contact information may include an e-mail address, telephone number, mailing address, or social media account names. In various embodiments, system computer device 102 may be configured to identify a responsible party or user 106 for property 108. In some embodiments, user 106 (shown in FIG. 2) may have registered with system computer device 102 for data processing and transmitting notification message 142.

In some embodiments, user 106 may have directed insurance agency 138 to identify user 106 as a registered party associated with the property 108 and/or a policyholder having a policy for the property 108. Additionally, or alternatively, system computer device 102 may access a database to obtain information related to property 108 including at least ownership information. In certain embodiments, system computer device 102 may use a network to access the database containing information identifying the responsible party. In some embodiments if a responsible party is identified, system computer device 102 may retrieve contact information for the identified responsible party and/or the registered user 106.

In some embodiments, computer-implemented method 300 may include system computer device 102 generating, e.g., training, or tuning, evacuation model 210. Generating may include training evacuation model 210 using a training dataset including, for example, historic evacuation records including historic evacuation order messages, the historically determined evacuation areas, the evacuation event, evacuation times, incident reports, and/or insurance claims associated with the historic evacuation order, and/or associated location of the residence or property 108.

In certain embodiments, computer-implemented method 300 may include system computer device 102 applying a plurality of model inputs to evacuation model 210 to determine one or more model outputs. Model inputs may include parsed and translated data, generated by translation module 206, from one or more current evacuation order messages 114 and incident reports 124. Model inputs may include data contained in one or more parametric user records 132. Model outputs may include a determination of one or more of the following: evacuation travel data 226, identified impacted users and/or impacted parametric user records 220, monitoring rates 222, notification message data, event/incident data 212 and/or event/incident area data 218.

In some embodiments, system computer device 102, and/or evacuation model 210, may determine a score for the property 108. In various embodiments, the score may be associated with a monetary value. Additionally, or alternatively, the score may be solely related to the parametric insurance policy, and funds are distributed based upon the score, regardless of the value of the property 108. In some embodiments the score may be determined using factors such as insurance coverage policy, evacuation travel data 226, location of the property 108, evacuation times, etc.

In some aspects, computer-implemented method 300 may be implemented via one or more local or remote processors, servers, transceivers, sensors, smart sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. All of the electronic or electrical components may be configured to operate as input and/or output devices. For instance, various types of voice bots or chatbots may be configured to interact with a human user (e.g., user 106) or other computing devices.

### Exemplary Map for Displaying an Evacution

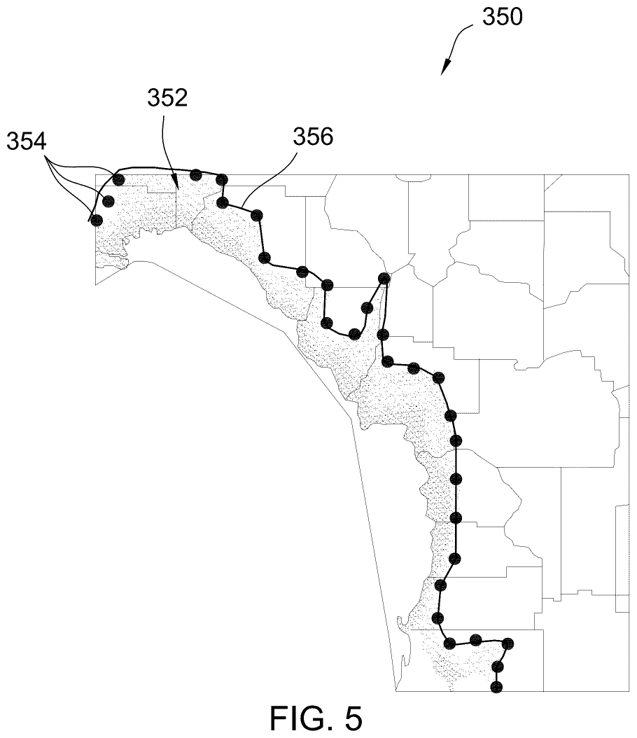

FIG. 5 is an exemplary map 350 generated by evacuation system shown in FIG. 1. System computer device 102 may generate map 350 using evacuation or incident area data 214, 218. System computer device 102 may generate map 350 using translation module 206 which translates the evacuation area parsed from the evacuation order message 114 into a format suitable for further data processing, such as for use in comparing to residence locations for identifying impacted users and/or impacted parametric user records 220.

In some embodiments, system computer device 102 may translate evacuation area to a plurality of endpoints 354 to define a boundary 356 associated with evacuation or incident area data 214, 218. System computer device 102 may determine any suitable number of endpoints spaced any suitable distance apart to generate the boundary 356.

In various embodiments, system computer device 102 may compare residence locations to the boundary 356 to identify of impacted users and/or impacted parametric user records 220. System computer device 102 may generate map 350 using any suitable graphics or image applications, e.g., an application program interface, which may cause user computing device 104 to display the map 350.

### Exemplary Computer Network

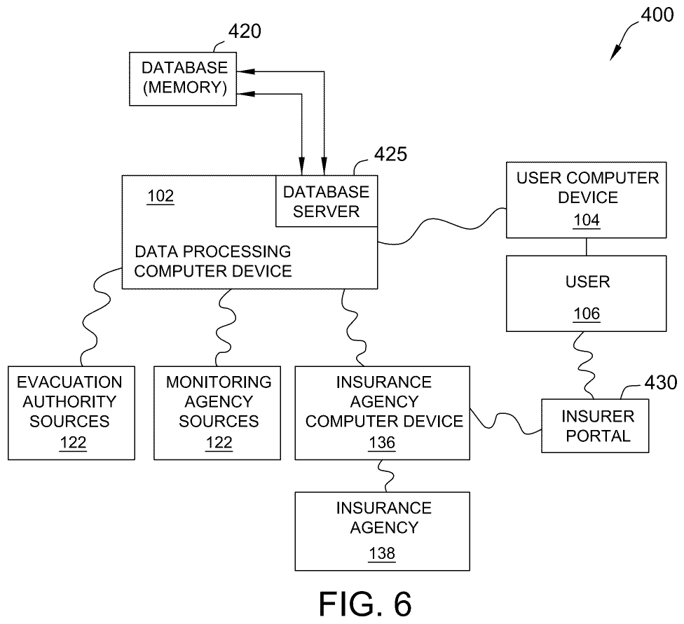

FIG. 6 depicts a simplified block diagram of an exemplary computer system 400 for implementing computer-based method 300 (shown in FIG. 4). In the exemplary embodiment, system 400 may be used for data processing and providing notification messages 142. As described below in more detail, a system computer device 102 (shown in FIG. 2) may be configured to i) electronically detect an evacuation order message associated with an evacuation authority, ii) parse the evacuation order message to determine one or more endpoints of an evacuation area identified in the evacuation order message, iii) determine a geographic area between the one or more endpoints, the geographic area defining the evacuation area, iv) identify a residence or property location located within the evacuation area that has a parametric user record associated therewith, v) in response to determining that the residence location is located within the evacuation area, identify a user computer device associated with the residence location, and/or vi) transmit an notification message to the user computer device that identifies the residence location as being located within the evacuation area in accordance with the parametric user record.

In some embodiments, user computer device 104 (shown in FIG. 2) may be a computer that includes a web browser or a software application which enables user computer device 104 to access remote computer devices, such as system computer device 102 using the Internet or other network as described herein. More specifically, user computer device 104 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer device 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiment a user (shown in FIG. 2) may be in communication with an insurer portal 430. Insurer portal 430 may be communicatively coupled to an insurance agency 138 through an insurance computer device 136. In some embodiments, an insurance agency 138 may be associated with user, who has a parametric insurance policy with insurance agency 138. Additionally, or alternatively, insurance agency 138 may communicate with user 106 through insurer portal 430 or user computer device 104. In some embodiments, insurer portal 430 may be a web page or website. In various embodiments, user computer device 104 may be communicatively coupled to insurer portal 430. User 106 may initiate a communication with insurer portal 430 through user computer device 104. In some embodiments, insurer portal 430 may be communicatively coupled with system computer device 102.

System computer device 102 may be part of a server system which includes database server 425. Database server 425 may be communicatively coupled to a database 420 that stores data. In the exemplary embodiment, database 420 may be stored locally on system computer device 102. In some embodiments, database 420 may be stored remotely from system computer device 102 and may or may not be decentralized. In the exemplary embodiment, user 106 may access database 420 via user computer device 104 by logging onto system computer device 102 as described herein.

System computer device 102 may be communicatively coupled with one or more user computer devices 104. In some embodiments, system computer device 102 may also be communicatively coupled with evacuation authority 112 through evacuation sources 110. In some embodiments, system computer device 102 may be associated with or may be part of a computer network associated with an insurance agency 138, or in communication with insurance computer device 136. In some embodiments, insurance computer device 136 may be in communication with insurance agency 138. Additionally, or alternatively, system computer device 102 may be associated with a third party and may merely be in communication with the insurance provider's computer network. More specifically, system computer device 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and/or a cable modem.

### Exemplary Client Device

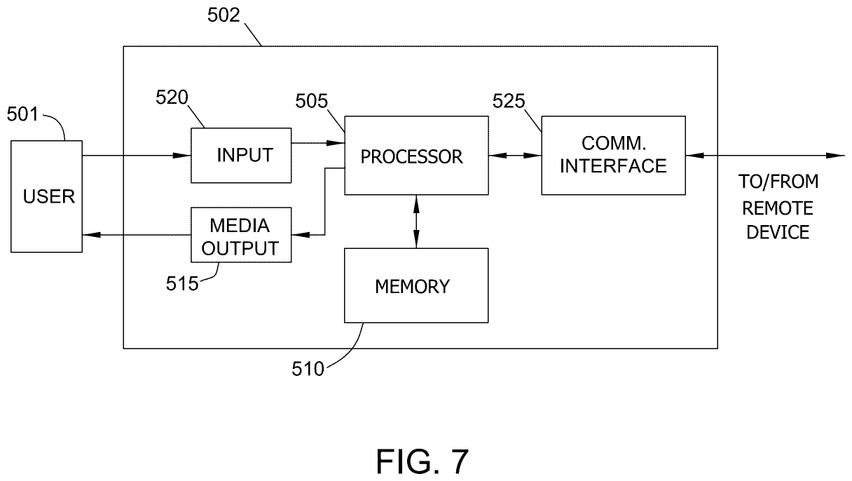

FIG. 7 depicts an exemplary configuration of a user computer device 502, such as user computer device 104 (shown in FIG. 2), in accordance with one embodiment of the present disclosure. User computer device 502 may be operated by a user 501. User computer device 502 may include, but may not be limited to, user computer devices 104 or system computer device 102 (both shown in FIG. 2). User computer device 502 may include a processor 505 for executing instructions.

In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones), virtual headsets (e.g., AR (Augmented Reality), VR (Virtual Reality), or XR (extended Reality) headsets), and/or voice or chat bots, including bots associated or configured with machine learning and/or generative AI (artificial intelligence) such as ChatGPT or ChatGPT iterations.

In some embodiments, media output component 515 may be configured to present a graphical user interface (e.g., a web browser and/or a client application) to user 501. A graphical user interface may include, for example, an online interface or an application program interface for viewing map 350, viewing notification messages and/or a wallet application for managing payment information or accepting funds. In some embodiments, user computer device 502 may include an input device 520 for receiving input from user 501. User 501 may use input device 520 to, without limitation, select and/or enter one or more items about safe areas, reservations, and/or relocation times and dates.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as system computer device 102 or insurance computer device 136 (shown in FIG. 2). Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from system computer device 102. For example, instructions may be stored by a cloud service, and the output of the execution of the instructions sent to the media output component 515.

### Exemplary Server Device

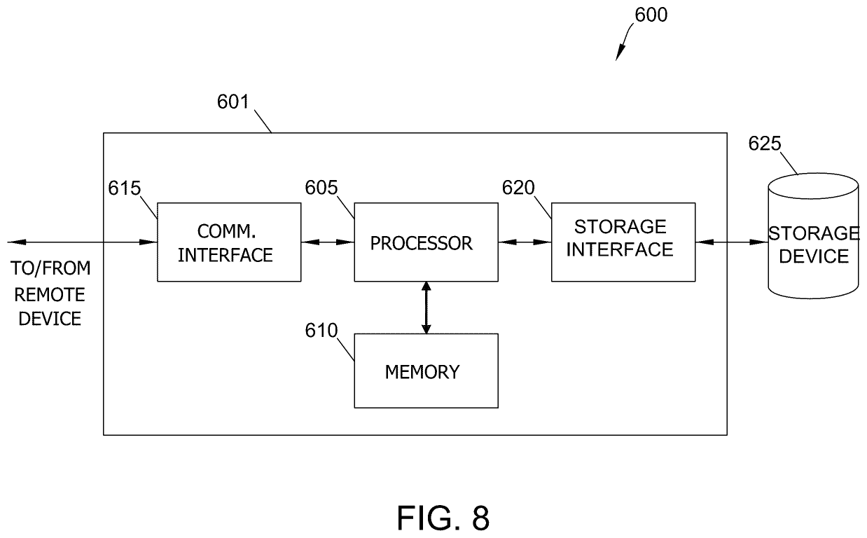

FIG. 8 depicts an exemplary configuration 600 of a server computer device 601, in accordance with one embodiment of the present disclosure. In the exemplary embodiment, server computer device 601 may be similar to, or the same as, system computer device 102 (shown in FIG. 1). Server computer device 601 may include, but may not be limited to, system computer device 102, insurance computer device 136 (shown in FIG. 2), and database server 425 (shown in FIG. 6). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 may be capable of communicating with a remote device such as another server computer device 601, system computer device 102, and user computer devices 104 (shown in FIG. 2) (for example, using wireless communication or data transmission over one or more radio links or digital communication channels). For example, communication interface 615 may receive requests from user computer devices 104 via the Internet, as illustrated in FIG. 6.

Processor 605 may also be operatively coupled to a storage device 634. Storage device 634 may be any computer-operated hardware suitable for storing and/or retrieving data, such as, but not limited to, data associated with database 420 (shown in FIG. 6). In some embodiments, storage device 634 may be integrated in server computer device 601. For example, server computer device 601 may include one or more hard disk drives as storage device 634.

In some embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIG. 4.

### Exemplary Computer Device

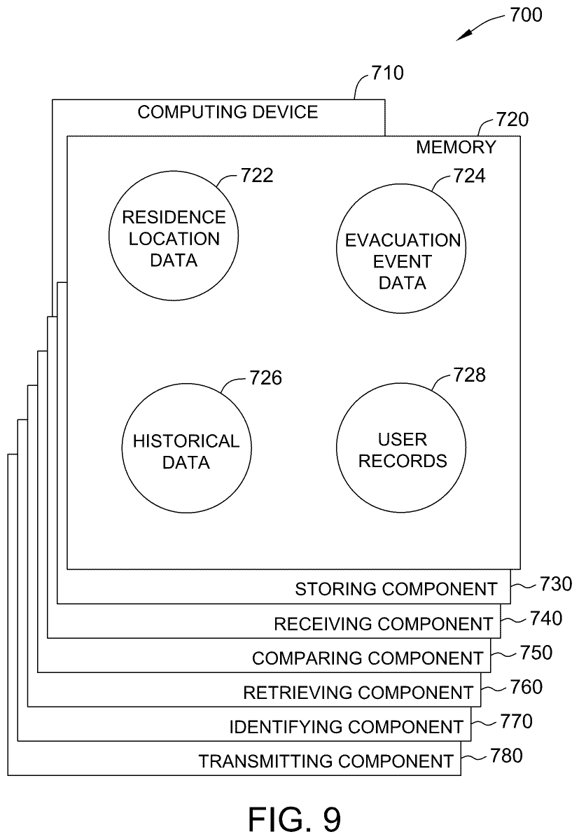

FIG. 9 depicts a diagram 700 of components of one or more exemplary computer devices 710 that may be used in system 400 (shown in FIG. 6). In some embodiments, computer device 710 may be similar to system computer device 102 (shown in FIG. 2). Memory 720 may be coupled with several separate components within computer device 710, which perform specific tasks. In the exemplary embodiment, memory 720 may include residence or property location data 722, evacuation or incident event data 724, historic data 726, and/or user records 728 (e.g., parametric user records 132). In some embodiments, memory 720 may be similar to database 420 (shown in FIG. 6). Historic data 724 may include historic evacuation records 140 associated with historically submitted policy claims associated with an evacuation event.

Computer device 710 may include memory 720, as well as a storing component 730 for storing user records 728 for registered users 106 and/or event/incident area data 214, 218, and/or event/incident data 212, 216. Computer device 710 may also include a receiving component 740 for receiving evacuation event data 724 for an impact area. Computer device 710 may further include a comparing component 750 for determining whether residence location data 722 may be in the evacuation area using at least evacuation event data 724, residence location data 726, and/or user records 728.

Computer device 710 may include a retrieving component 760 for retrieving or parsing contact information to inform the registered user and/or a responsible party. Computer device 710 may also include an identifying component 770 to determine evacuation funds. Computer device 710 may also include a transmitting component 780 to communicate with other internal and/or external components to at least transmit the result of comparing component 750. In some embodiments, transmitting component 780 may also transmit evacuation event data 724 evacuation travel data, and/or evacuation route data.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or operation recited in the singular and preceded by the word “a” or “an” should be understood as not excluding plural elements or operations, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer system for implementing a parametric evacuation system to analyze evacuation order messages, the computer system comprising at least one processor, a rules engine, and at least one memory, the at least one processor programmed to:
electronically detect an evacuation order message associated with an evacuation authority;
parse the evacuation order message to determine one or more endpoints of an evacuation area identified in the evacuation order message;
determine a geographic area between the one or more endpoints, the geographic area defining the evacuation area;
identify, by applying the rules engine, a property location located within the evacuation area;
determine, by applying the rules engine, that a parametric insurance policy associated with the property location is triggered; and
electronically transmit a notification message to an insured party associated with the parametric insurance policy notifying the party that funds associated with the parametric insurance policy have been transferred to the insured party.

2. The computer system of claim 1, wherein the at least one processor is further programmed to:
verify an identity of the evacuation authority; and
monitor an evacuation source associated with the verified evacuation authority for evacuation order messages.

3. The computer system of claim 1, wherein the at least one processor is further programmed to:
verify a plurality of different evacuation authorities; and
continuously monitor electronic evacuation sources associated with the verified evacuation authorities for evacuation order messages.

4. The computer system of claim 1, wherein the at least one processor is further programmed to:
build a first training dataset including a plurality of historic evacuation orders, each historic evacuation orders comprising an evacuation area and a historic evacuation policy claim associated with the historic evacuation orders; and
train, in a first training session, an evacuation model using the first training dataset.

5. The computer system of claim 4, wherein the processor is further programmed to:
build a second training dataset including a plurality of historic evacuation records, each historic evacuation order including a historic evacuation area, a plurality of historic evacuation policy claims associated with the historic evacuation order, wherein each of the plurality of claims includes a property location impacted by the historic evacuation order, and historic incident records associated with a historic incident event including a historic incident area; and
train, in a second training session, the evacuation model using the second training dataset.

6. The computer system of claim 4, wherein the processor is further programmed to apply the parsed one or more endpoints of the evacuation area to the evacuation model, wherein an output from the evacuation model identifies a property location located within the evacuation area that has a parametric user record associated therewith.

7. The computer system of claim 1, wherein the processor is further programmed to:
detect an incident report associated with a monitoring agency;
parse the incident report to determine one or more endpoints of an incident area identified in the incident report;
determine a geographic area between the one or more endpoints, the geographic area defining the incident area; and
identify, by applying the rules engine, a property location located within the incident area that has a parametric user record associated therewith.

8. The computer system of claim 7, wherein the processor is further programmed to:
apply the parsed one or more endpoints of the incident area to an evacuation model trained to identify a property location located within the incident area that has a parametric user record associated therewith.

9. The computer system of claim 7, wherein the processor is further programmed to:
parse the parametric user record to determine a funds amount; and
transmit the notification message including the funds amount.

10. The computer system of claim 1, wherein the processor is further programmed to:
determine, based in part the determined one or more endpoints of an evacuation area and the property location, evacuation travel data including at least one of evacuation travel routes, evacuation travel duration, and evacuation travel cost.

11. A computer-based method for implementing a parametric evacuation system to analyze evacuation order messages, implemented by at least one processor in communication with at least one memory and a rules engine, said method comprising:
detecting an evacuation order message associated with an evacuation authority;
parsing the evacuation order message to determine one or more endpoints of an evacuation area identified in the evacuation order message;
determining a geographic area between the one or more endpoints, the geographic area defining the evacuation area;
identifying, by applying the rules engine, a property location located within the evacuation area;
determining, by applying the rules engine, that a parametric insurance policy associated with the property location is triggered; and
electronically transmitting a notification message to an insured party associated with the parametric insurance policy notifying the party that funds associated with the parametric insurance policy have been transferred to the insured party.

12. The computer-based method of claim 11, wherein the method further includes:
verifying an identity of the evacuation authority; and
monitoring an evacuation source associated with the verified evacuation authority for evacuation order messages.

13. The computer-based method of claim 11, wherein the method further includes:
verifying a plurality of different evacuation authorities; and
continuously monitor electronic evacuation sources associated with the verified evacuation authorities for evacuation order messages.

14. The computer-based method of claim 11, wherein the method further includes:
building a first training dataset including a plurality of historic evacuation orders, each historic evacuation orders comprising an evacuation area, and historic evacuation policy claims associated with the historic evacuation order; and
training, in a first training session, an evacuation model using the first training dataset.

15. The computer-based method of claim 14, wherein the method further includes:
building a second training dataset including a plurality of historic evacuation orders, each historic evacuation order including a historic evacuation area, a plurality of historic evacuation policy claims associated with the historic evacuation orders, wherein each of the plurality of claims includes a property location impacted by the historic evacuation order, and historic incident records associated with a historic incident event including a historic incident area; and
training, in a second training session, the evacuation model using the second training dataset.

16. At least one non-transitory computer-readable storage media having computer-executable instructions embodied thereon for implementing a parametric evacuation system to analyze evacuation order messages, wherein when executed by at least one processor and a rules engine, the computer-executable instructions cause the at least one processor to:
electronically detect an evacuation order message associated with an evacuation authority;
parse the evacuation order message to determine one or more endpoints of an evacuation area identified in the evacuation order message;
determine a geographic area between the one or more endpoints, the geographic area defining the evacuation area;
identify, by applying the rules engine, a property location located within the evacuation area;
determine, by applying the rules engine, that a parametric insurance policy associated with the property location is triggered; and
electronically transmit a notification message to an insured party associated with the parametric insurance policy notifying the party that funds associated with the parametric insurance policy have been transferred to the insured party.

17. The computer-readable storage media of claim 16, wherein the at least one processor is further programmed to:
verify an identity of the evacuation authority; and
monitor an evacuation source associated with the verified evacuation authority for evacuation order messages.

18. The computer-readable storage media of claim 16, wherein the at least one processor is further programmed to:
verify a plurality of different evacuation authorities; and
continuously monitor electronic evacuation sources associated with the verified evacuation authorities for evacuation order messages.

19. The computer-readable storage media of claim 16, wherein the at least one processor is further programmed to:
build a first training dataset including a plurality of historic evacuation orders, each historic evacuation orders including an evacuation area and a historic evacuation policy claim associated with the historic evacuation orders; and
train, in a first training session, an evacuation model using the first training dataset.

20. A computer system for generating parametric-based notification messages using artificial intelligence tools, the computer system comprising at least one processor, a rules engine, and at least one memory in communication with the at least one processor, the at least one processor programmed to:
build a training dataset including a plurality of historic evacuation orders, each historic evacuation order including (a) a historic evacuation area, (b) a plurality of historic evacuation policy claims associated with the historic evacuation orders, wherein each of the plurality of claims includes a property location impacted by the historic evacuation order, and (c) a plurality of historic incident records associated with a historic incident event including a historic incident area;
generate an evacuation model using the training dataset, the evacuation model is trained to generate one or more model outputs when one or more model inputs are applied to the evacuation model, wherein the model outputs include at least one of (a) one or more endpoints of an evacuation area identified in the evacuation order, (b) a geographic area between the one or more endpoints defining the evacuation area, (c) a property location located within the evacuation area, (d) a parametric insurance policy associated with the property location is triggered;
apply a current incident record to the trained evacuation model to generate (a) a property location located within the evacuation area, (b) a parametric insurance policy associated with the property location, (c) notification message to an insured party associated with the parametric insurance policy notifying the party that funds associated with the parametric insurance policy have been transferred to the insured party; and
transmit a notification message to an insured party associated with the parametric insurance policy notifying the party that funds associated with the parametric insurance policy have been transferred to the insured party.

21. The computer system of claim 20, wherein the training dataset includes evacuation travel data for impacted parametric user records and wherein the trained evacuation model generates evacuation travel data associated with the property location located within the evacuation area.
